(19) United States
(12) Patent Application Publication
(10) Pub. No.: US 2018/0029048 A1
(43) Pub. Date: Feb. 1, 2018

(54) CENTRIFUGAL SEPARATORS FOR USE IN SEPARATING A MIXED STREAM OF AT LEAST TWO FLUIDS

(71) Applicant: General Electric Company, Schenectady, NY (US)

(72) Inventors: Chengbao Wang, Oklahoma City, OK (US); Subrata Pal, Bangalore (IN); Anindya Kanti De, Bangalore (IN); Shyam Sivaramakrishnan, Fremont, CA (US); Brian Paul Reeves, Edmond, OK (US); Mahendra Ladharam Joshi, Katy, TX (US); Stewart Blake Brazil, Edmond, OK (US); Catherine James, Oklahoma City, OK (US)

(21) Appl. No.: 15/661,134

(22) Filed: Jul. 27, 2017

Related U.S. Application Data
(60) Provisional application No. 62/367,158, filed on Jul. 27, 2016.

(51) Int. Cl. B04C 3/06; C02F 1/38; B01D 17/02

(52) U.S. Cl. CPC B04C 3/06; B01D 17/0217; C02F 1/38; E21B 43/34

(57) ABSTRACT

A centrifugal separator for separating a mixed stream including a first fluid and a second fluid. The separator includes a housing that extends from a first end to a second end. A first flow opening is at the first end, a second flow opening is at the second end, and a third flow opening is at the second end. A rotor assembly within the housing includes a rotor shaft and a cylindrical drum. The cylindrical drum includes an interior including an outer radial portion and an inner radial portion. The outer radial portion is in flow communication with the first flow opening and the second flow opening, and the inner radial portion is in flow communication with the third flow opening. The cylindrical drum is rotatable within the housing such that the first fluid flows along the outer radial portion, and such that the second fluid flows along the inner radial portion.

### CROSS-REFERENCE TO RELATED APPLICATIONS

This application claims priority to U.S. Provisional Application No. 62/367,158, filed Jul. 27, 2016 for “DESIGN OF CENTRIFUGAL SEPARATOR”, which is incorporated by reference herein in its entirety.

### BACKGROUND

The present disclosure relates generally to centrifugal separation and, more specifically, to centrifugal separators having improved separation efficiency for mixtures containing at least two fluids over a wide range of concentrations.

Hydraulic fracturing, commonly known as fracing, is a technique used to release petroleum, natural gas, and other hydrocarbon-based substances for extraction from underground reservoir rock formations, especially for unconventional reservoirs. The technique includes drilling a wellbore into the rock formations, and pumping a treatment fluid into the wellbore, which causes fractures to form in the rock formations and allows for the release of trapped substances produced from these subterranean natural reservoirs.

At least some known treatment fluids are formed at least partially from water, and the water is sometimes released from the fractures and backflows into the wellbore such that a mixture of water and released hydrocarbon-based substances is formed. The water and hydrocarbon-based substances are then separated from each other such that the hydrocarbon-based substances can be recovered for subsequent refinement. However, at least some known separating devices, such as hydro-cyclones, have a high pressure drop and a narrow operating range. Moreover, separating devices that include blades or vanes may emulsify the mixture during separation, which reduces the separation efficiency of the device.

### BRIEF DESCRIPTION

In one aspect, a centrifugal separator for use in separating a mixed stream of at least a first fluid and a second fluid is provided. The centrifugal separator includes a stator assembly including a housing defining a longitudinal axis of the centrifugal separator. The housing extends from a first end to a second end along the longitudinal axis, and the housing includes a first flow opening defined at the first end of the housing, a second flow opening defined at the second end of the housing, and a third flow opening defined at the second end of the housing. A rotor assembly is positioned within the housing. The rotor assembly includes a rotor shaft and a cylindrical drum coupled to the rotor shaft. The cylindrical drum includes a first open end and a second open end, and the cylindrical drum is configured to receive the mixed stream through at least one of the first open end and the second open end. The cylindrical drum further includes an interior including an outer radial portion and an inner radial portion. The outer radial portion is in flow communication with the first flow opening and the second flow opening, and the inner radial portion is in flow communication with the third flow opening. The cylindrical drum is rotatable within the housing such that the first fluid flows along the outer radial portion, and such that the second fluid flows along the inner radial portion.

In another aspect, a centrifugal separator for use in separating a mixed stream of at least a first fluid and a second fluid. The centrifugal separator includes a stator assembly including a housing defining a longitudinal axis of the centrifugal separator. The housing extends from a first end to a second end along the longitudinal axis, and the housing includes a first flow opening defined at the first end of the housing, a second flow opening defined at the first end of the housing, and a third flow opening defined at the second end of the housing. A rotor assembly is positioned within the housing, and the rotor assembly includes a cylindrical drum. The cylindrical drum includes a first open end configured to receive the mixed stream therethrough, a second open end, and an interior including an outer radial portion and an inner radial portion. The outer radial portion is in flow communication with the first flow opening and the third flow opening, and the inner radial portion is in flow communication with the second flow opening. The cylindrical drum is rotatable within the housing such that the first fluid flows along the outer radial portion, and such that the second fluid flows along the inner radial portion. The rotor assembly further includes a rotor shaft coupled to the cylindrical drum, wherein the rotor shaft includes a side wall defining an internal flow channel that provides flow communication between the inner radial portion of the interior and the second flow opening.

### DRAWINGS

These and other features, aspects, and advantages of the present disclosure will become better understood when the following detailed description is read with reference to the accompanying drawings in which like characters represent like parts throughout the drawings, wherein:

FIG. 1 is a cross-sectional side view of an exemplary centrifugal separator in a first operating condition;

FIG. 2 is a cross-sectional side view of a first end of the centrifugal separator shown in FIG. 1;

FIG. 3 is a cross-sectional side view of a second end of the centrifugal separator shown in FIG. 1;

FIG. 4 is a cross-sectional side view of the centrifugal separator shown in FIG. 1 in a second operating condition;

FIG. 5 is a cross-sectional side view of an alternative centrifugal separator;

FIG. 6 is a cross-sectional side view of a first end of the centrifugal separator shown in FIG. 5; and

FIG. 7 is a cross-sectional side view of a second end of the centrifugal separator shown in FIG. 5.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged. Such ranges are identified and include all the sub-ranges contained therein unless context or language indicates otherwise.

As used herein, the terms “axial” and “axially” refer to directions and orientations that extend substantially parallel to a longitudinal axis of the centrifugal separator. Moreover, the terms “radial” and “radially” refer to directions and orientations that extend substantially perpendicular to the longitudinal axis of the centrifugal separator. In addition, as used herein, the terms “circumferential” and “circumferentially” refer to directions and orientations that extend arcuately about the longitudinal axis of the centrifugal separator.

Embodiments of the present disclosure relate to centrifugal separators having improved separation efficiency for mixtures containing at least two fluids over a wide range of concentrations. More specifically, the centrifugal separators described herein include a rotor assembly including a cylindrical drum that receives a mixed stream of the at least two fluids, and that rotates to facilitate separating the mixed stream into its component parts. For example, the cylindrical drum induces rotational motion to the mixed stream as it rotates, and due to a centrifugal force induced by the rotational motion, a heavier first fluid (e.g., water) accumulates on an outer radial portion of the cylindrical drum and a lighter second fluid (e.g., oil) collects on an inner radial portion of the cylindrical drum. The centrifugal separators further include a stator assembly including a housing having flow openings positioned to discharge the separated fluid streams from the housing.

In general, the separation efficiency of the centrifugal separators is based on a distance that discharge outlets for the first fluid and the second fluid are positioned from a separation interface formed between the first fluid and the second fluid within the cylindrical drum. In one embodiment, such as when the centrifugal separator is used to separate a mixed stream that contains greater than about 70 percent water by volume and the remainder substantially oil, the discharge outlets are positioned at the same end of the housing while still achieving suitable separation efficiency. In a second embodiment, such as when the centrifugal separator is used to separate a mixed stream that contains greater than about 30 percent water by volume and the remainder substantially oil, the discharge outlets are positioned on opposing ends of the housing. As such, the centrifugal separators described herein facilitate separating mixtures in a space-saving and efficient manner.

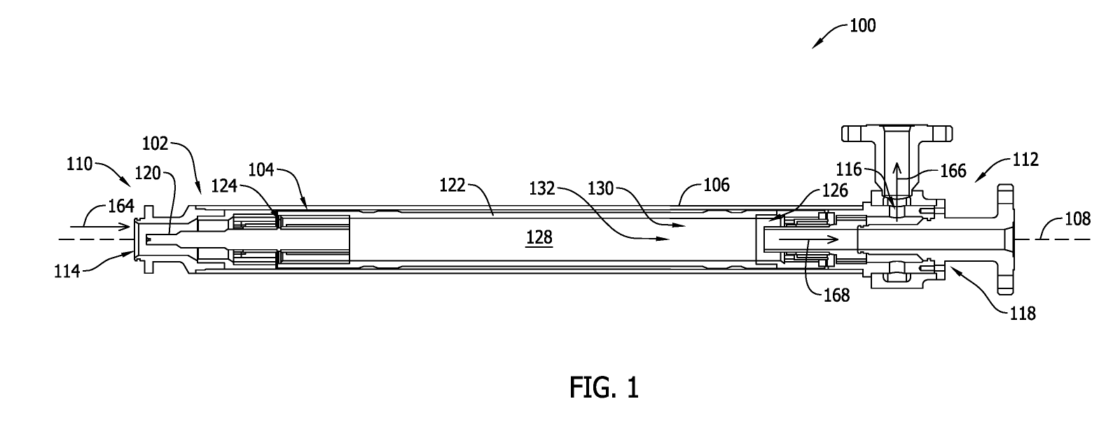

FIGS. 1-3 are cross-sectional side views of an exemplary centrifugal separator 100. Referring to FIG. 1, centrifugal separator 100 includes a stator assembly 102 and a rotor assembly 104. Stator assembly 102 includes a housing 106 that defines a longitudinal axis 108 of centrifugal separator 100. Housing 106 extends from a first end 110 to a second end 112 along longitudinal axis 108. In addition, housing 106 includes a first flow opening 114 defined at first end 110 of housing 106, a second flow opening 116 defined at second end 112 of housing 106, and a third flow opening 118 defined at second end 112 of housing 106.

In the exemplary embodiment, rotor assembly 104 includes a rotor shaft 120 and a cylindrical drum 122 coupled to rotor shaft 120. When in use, rotor shaft 120 is coupled to a prime mover (not shown), which induces rotation of cylindrical drum 122. Cylindrical drum 122 includes a first open end 124, a second open end 126, and an interior 128 including an outer radial portion 130 and an inner radial portion 132. As will be explained in further detail below, outer radial portion 130 is in flow communication with first flow opening 114 and second flow opening 116, and inner radial portion 132 is in flow communication with third flow opening 118.

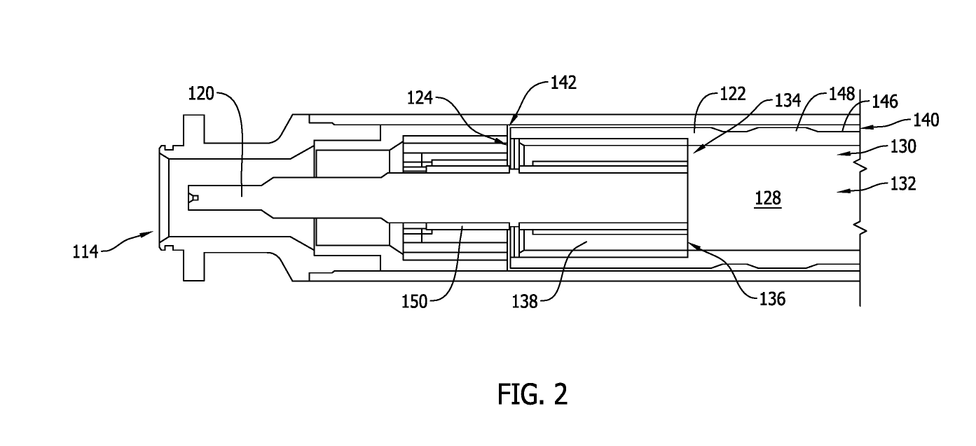

Referring to FIG. 2, rotor shaft 120 extends through first open end 124 of cylindrical drum 122 such that a first annular flow channel 134 is defined between rotor shaft 120 and cylindrical drum 122. First annular flow channel 134 provides flow communication between outer radial portion 130 of interior 128 and first flow opening 114. Rotor assembly 104 further includes a perforated coupling member 136 extending between rotor shaft 120 and cylindrical drum 122. More specifically, in the exemplary embodiment, perforated coupling member 136 includes a plurality of vanes 138 extending radially between rotor shaft 120 and cylindrical drum 122, and that are spaced from each other circumferentially about rotor shaft 120. As such, perforated coupling member 136 allows fluid flow through first annular flow channel 134.

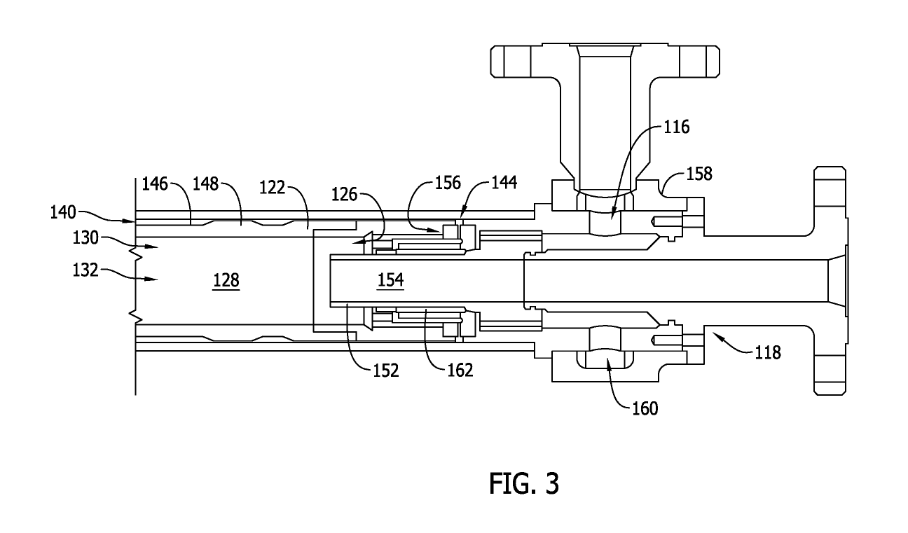

As shown in FIG. 2, cylindrical drum 122 is spaced from housing 106 such that an annular cavity 140 is defined therebetween. In addition, cylindrical drum 122 is spaced from stator assembly 102 at both first open end 124 and second open end 126 such that fluid within housing 106 is allowed to flow into annular cavity 140. Referring to FIG. 2, a first leakage flow path 142 is defined at first open end 124 of cylindrical drum 122 and, referring to FIG. 3, a second leakage flow path 144 is defined at second open end 126 of cylindrical drum 122. As such, the fluid channeled into annular cavity 140 through either first leakage flow path 142 or second leakage flow path 144 provides lubrication between cylindrical drum 122 and housing 106.

Moreover, cylindrical drum 122 includes an outer surface 146 having at least one balancing member 148 extending therefrom. The at least one balancing member 148 is selectively abradable from cylindrical drum 122 to modify a center of mass of cylindrical drum 122. More specifically, balancing member 148 provides excess material that is removable from cylindrical drum 122 in the event an imbalance in cylindrical drum 122 is determined during rotation thereof. As such, the center of mass of cylindrical drum 122 is modifiable without affecting its structural integrity.

As noted above, rotor assembly 104 rotates relative to stator assembly 102 when centrifugal separator 100 is in operation. As such, centrifugal separator 100 includes a first bearing 150 coupled between stator assembly 102 and rotor assembly 104 and, more specifically, coupled between stator assembly 102 and rotor shaft 120. First bearing 150 is any bearing that enables centrifugal separator 100 to function as described herein. In one embodiment, first bearing 150 is a hydrodynamic thrust bearing, or a ground face seal bearing, fabricated at least partially from tungsten carbide material.

Referring to FIG. 3, stator assembly 102 further includes an intake nozzle 152 that extends through second open end 126 of cylindrical drum 122. Intake nozzle 152 includes a first flow channel 154 extending therethrough for providing flow communication between inner radial portion 132 of interior 128 and third flow opening 118. In addition, intake nozzle 152 is spaced from housing 106 and cylindrical drum 122 such that a second annular flow channel 156 is defined between intake nozzle 152 and cylindrical drum 122. Second annular flow channel 156 provides flow communication between outer radial portion of interior 128 and second flow opening 116. As will be explained in further detail below, intake nozzle 152 is sized radially to facilitate intersecting an oil/water interface formed within interior 128 when centrifugal separator 100 is in operation.

In the exemplary embodiment, second flow opening 116 is oriented radially within housing 106 relative to longitudinal axis 108 (shown in FIG. 1). In one embodiment, stator assembly 102 further includes a ring member 158 extending circumferentially about housing 106 and defining an annular plenum 160 therebetween. Ring member 158 is positioned relative to housing 106 such that annular plenum 160 and second flow opening 116 are in flow communication. As such, fluid discharged from second flow opening 116 is collected in annular plenum 160 and discharged from centrifugal separator 100 in a continuous and efficient manner. Alternatively, when fluid is channeled into housing 106 through second flow opening 116, annular plenum 160 facilitates channeling the fluid into housing 106 in a continuous and efficient manner.

As noted above, rotor assembly 104 rotates relative to stator assembly 102 when centrifugal separator 100 is in operation. As such, centrifugal separator 100 includes a second bearing 162 coupled between stator assembly 102 and rotor assembly 104 and, more specifically, coupled between stator assembly 102 and intake nozzle 152. Second bearing 162 is any bearing that enables centrifugal separator 100 to function as described herein. In one embodiment, second bearing 162 is a hydrodynamic thrust bearing, or a ground face seal bearing, fabricated at least partially from tungsten carbide material.

Referring again to FIG. 1, centrifugal separator 100 is shown in a first operating condition. In the exemplary embodiment, first flow opening 114 is defined as a flow inlet, and second flow opening 116 and third flow opening 118 are both defined as flow outlets. In operation, a mixed stream 164 of at least a first fluid and a second fluid is channeled through first flow opening 114 and into cylindrical drum 122 through first annular flow channel 134 (shown in FIG. 2). In the exemplary embodiment, the first fluid has a greater unit weight than the second fluid. For example, in one embodiment, the first fluid is water and the second fluid is a hydrocarbon-based substance such as oil.

Cylindrical drum 122 is rotatable within housing 106 and induces a shearing force to mixed stream 164 received therein. More specifically, cylindrical drum 122 is rotatable within housing 106 such that the first fluid flows along outer radial portion 130 of interior 128, and such that the second fluid flows along inner radial portion 132 of interior 128. For example, mixed stream 164 is progressively separated into its component parts as mixed stream 164 is channeled from first end 110 towards second end 112. As noted above, intake nozzle 152 (shown in FIG. 3) is sized to facilitate intersecting an interface between the first fluid and the second fluid formed within interior 128 when centrifugal separator 100 is in operation. As such, a first stream 166 formed substantially from the first fluid is channeled through second annular flow channel 156 (shown in FIG. 3) and discharged from second flow opening 116, and a second stream 168 formed substantially from the second fluid is channeled through first flow channel 154 (shown in FIG. 3) and discharged from third flow opening 118.

In the first operating condition, centrifugal separator 100 facilitates separating mixed stream 164 that contains greater than about 70 percent water by volume, for example.

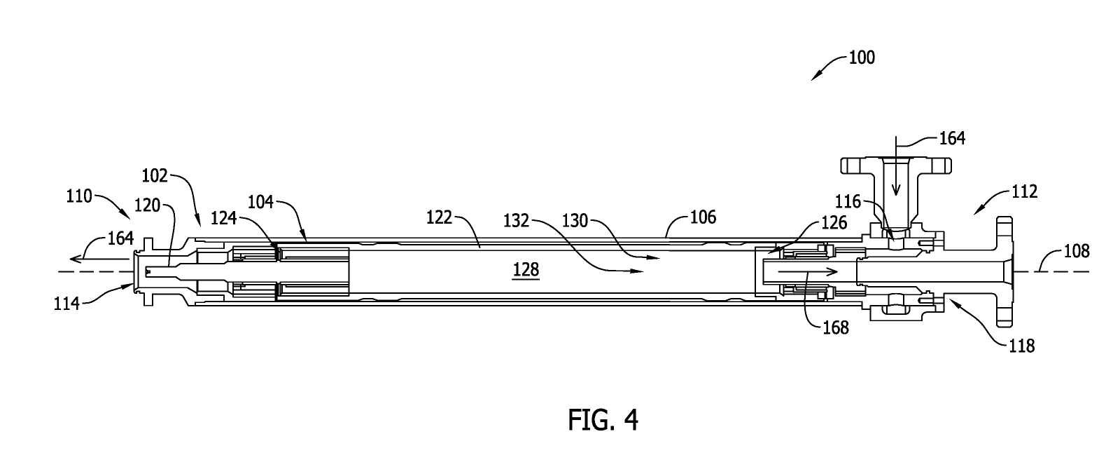

FIG. 4 is a cross-sectional side view of centrifugal separator 100 in a second operating condition. In the exemplary embodiment, first flow opening 114 is defined as a flow outlet, second flow opening 116 is defined as a flow inlet, and third flow opening 118 is defined as a flow outlet. In operation, mixed stream 164 is channeled through second flow opening 116 and into cylindrical drum 122 through second annular flow channel 156 (shown in FIG. 3). Cylindrical drum 122 is rotatable within housing 106 such that the first fluid flows along outer radial portion 130 of interior 128, and such that the second fluid flows along inner radial portion 132 of interior 128. For example, mixed stream 164 is progressively separated into its component parts as mixed stream 164 is channeled from second end 112 towards first end 110.

In the exemplary embodiment, rotor shaft 120 is a solid member that restricts the passage of fluid therethrough. As such, first stream 166 is channeled through first annular flow channel 134 (shown in FIG. 2) and discharged from first flow opening 114. Moreover, the centrifugal force created by the rotation of cylindrical drum 122 facilitates forming a high-pressure zone at outer radial portion 130 and a low-pressure zone at inner radial portion 132 proximate intake nozzle 152. In one embodiment, the second fluid accumulates within the low-pressure zone, and a negative pressure is induced at third flow opening 118 that facilitates drawing the second fluid therethrough. As such, first stream 166 formed substantially from the first fluid is discharged from first flow opening 114, and second stream 168 formed substantially from the second fluid is discharged from third flow opening 118.

In the second operating condition, centrifugal separator 100 facilitates separating mixed stream 164 that contains greater than about 30 percent water by volume, for example.

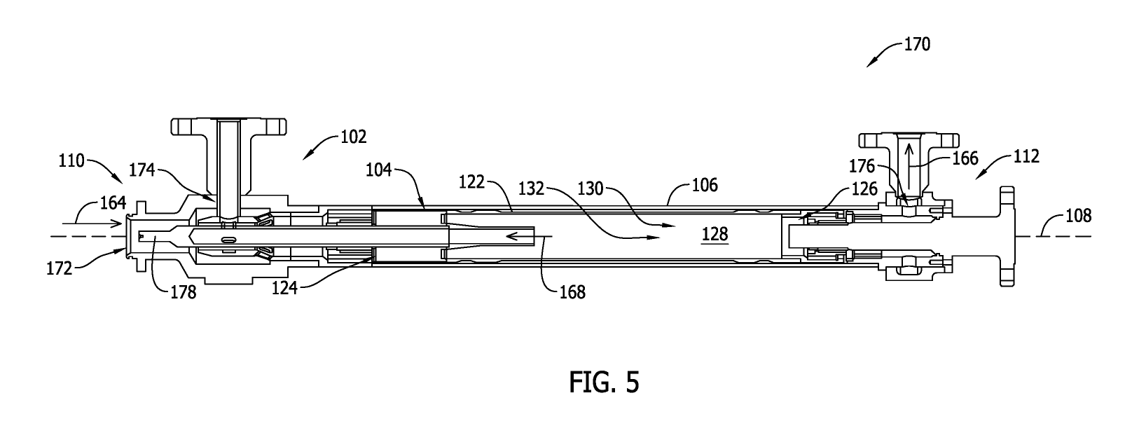

FIGS. 5-7 are cross-sectional side views of an alternative centrifugal separator 170. Referring to FIG. 5, housing 106 includes a first flow opening 172 defined at first end 110 of housing 106, a second flow opening 174 defined at first end 110 of housing 106, and a third flow opening 176 defined at second end 112 of housing 106.

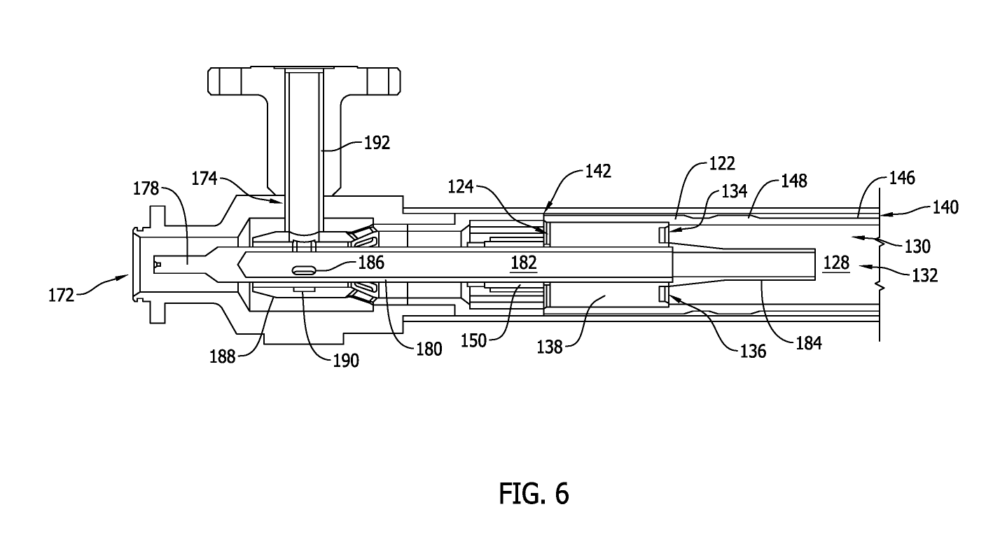

Referring to FIG. 6, rotor assembly 104 includes a rotor shaft 178 coupled to cylindrical drum 122. Rotor shaft 178 includes a side wall 180 defining an internal flow channel 182 that provides flow communication between inner radial portion 132 of interior 128 and second flow opening 174. In addition, rotor shaft 178 extends through first open end 124 such that first annular flow channel 134 is defined between rotor shaft 178 and cylindrical drum 122. In one embodiment, rotor assembly 104 further includes an intake nozzle 184 coupled to rotor shaft 178. Intake nozzle 184 extends a distance from rotor shaft 178 and is positioned within interior 128 of cylindrical drum 122. Intake nozzle 184 facilitates collecting the second fluid that flows along inner radial portion 132, as will be explained in further detail below.

In the exemplary embodiment, side wall 180 of rotor shaft 178 has a radial opening 186 defined therein. In one embodiment, radial opening 186 is in selective flow communication with second flow opening 174 as rotor shaft 178 rotates. More specifically, second flow opening 174 is at a fixed position relative to rotor assembly 104, and radial opening 186 aligns with second flow opening 174 at a certain point in the rotation of rotor shaft 178. Alternatively, stator assembly 102 further includes a ring member 188 extending circumferentially about rotor shaft 178 such that an annular plenum 190 is defined therebetween. Ring member 188 is positioned such that annular plenum 190 and radial opening 186 are in flow communication. Stator assembly 102 also includes a flow tube 192 extending between ring member 188 and second flow opening 174 such that flow communication is provided therebetween. As such, the second fluid may be continuously discharged from radial opening 186 and extracted through second flow opening 174.

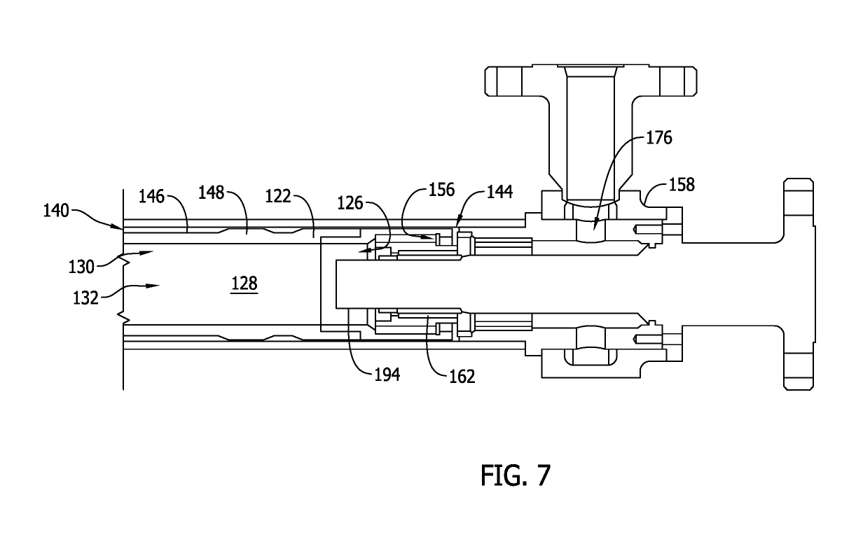

Referring to FIG. 7, stator assembly 102 further includes a plug member 194 extending through second open end 126 of cylindrical drum 122. Plug member 194 is a solid member that restricts the passage of fluid therethrough. Plug member 194 is also oriented such that second annular flow channel 156 is defined between plug member 194 and cylindrical drum 122.

Referring again to FIG. 5, first flow opening 172 is defined as a flow inlet, and second flow opening 174 and third flow opening 176 are both defined as flow outlets. In operation, mixed stream 164 is channeled through first flow opening 172 and into cylindrical drum 122 through first annular flow channel 134. Cylindrical drum 122 is rotatable within housing 106 such that the first fluid flows along outer radial portion 130 of interior 128, and such that the second fluid flows along inner radial portion 132 of interior 128. For example, mixed stream 164 is progressively separated into its component parts as mixed stream 164 is channeled from first end 110 towards second end 112.

As noted above, plug member 194 is a solid member that restricts the passage of fluid therethrough. As such, first stream 166 is channeled through second annular flow channel 156 (shown in FIG. 7) and discharged from third flow opening 176. Moreover, the centrifugal force created by the rotation of cylindrical drum 122 facilitates forming a high-pressure zone at outer radial portion 130 and a low-pressure zone at inner radial portion 132 proximate rotor shaft 178. In one embodiment, the second fluid accumulates within the low-pressure zone, and a negative pressure is induced at second flow opening 174 that facilitates drawing the second fluid therethrough. As such, first stream 166 formed substantially from the first fluid is discharged from third flow opening 176, and second stream 168 formed substantially from the second fluid is discharged from second flow opening 174.

An exemplary technical effect of the devices and methods described herein includes at least one of: (a) separating a mixture including at least two fluids having different densities; (b) providing devices that are capable of separating a mixture containing at least two fluids over a wide range of concentrations; and (c) providing an enhanced separation efficiency of the mixture.

Exemplary embodiments of centrifugal separators and related components are described above in detail. The devices are not limited to the specific embodiments described herein, but rather, components of systems and/or steps of the methods may be utilized independently and separately from other components and/or steps described herein. For example, the configuration of components described herein may also be used in combination with other processes, and is not limited to practice with only separating a mixture of fluids received from an oil and gas well and related methods as described herein. Rather, the exemplary embodiment can be implemented and utilized in connection with many applications where separating a mixture containing fluids having different densities is desired.

Although specific features of various embodiments of the present disclosure may be shown in some drawings and not in others, this is for convenience only. In accordance with the principles of embodiments of the present disclosure, any feature of a drawing may be referenced and/or claimed in combination with any feature of any other drawing.

This written description uses examples to disclose the embodiments of the present disclosure, including the best mode, and also to enable any person skilled in the art to practice embodiments of the present disclosure, including making and using any devices or systems and performing any incorporated methods. The patentable scope of the embodiments described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A centrifugal separator for use in separating a mixed stream of at least a first fluid and a second fluid, said centrifugal separator comprising:
a stator assembly comprising a housing defining a longitudinal axis of the centrifugal separator, wherein said housing extends from a first end to a second end along the longitudinal axis, and wherein said housing comprises:
a first flow opening defined at said first end of said housing;
a second flow opening defined at said second end of said housing; and
a third flow opening defined at said second end of said housing; and
a rotor assembly positioned within said housing, said rotor assembly comprising:
a rotor shaft; and
a cylindrical drum coupled to said rotor shaft, wherein said cylindrical drum comprises:
a first open end;
a second open end, said cylindrical drum configured to receive the mixed stream through at least one of said first open end and said second open end; and
an interior comprising an outer radial portion and an inner radial portion, said outer radial portion in flow communication with said first flow opening and said second flow opening, and said inner radial portion in flow communication with said third flow opening, wherein said cylindrical drum is rotatable within said housing such that the first fluid flows along said outer radial portion, and such that the second fluid flows along said inner radial portion.

2. The centrifugal separator in accordance with claim 1, wherein said rotor shaft extends through said first open end of said cylindrical drum such that a first annular flow channel is defined between said rotor shaft and said cylindrical drum, said first annular flow channel providing flow communication between said outer radial portion of said interior and said first flow opening.

3. The centrifugal separator in accordance with claim 2, wherein said rotor assembly further comprises a perforated coupling member extending between said rotor shaft and said cylindrical drum, said perforated coupling member configured to allow fluid flow through said first annular flow channel.

4. The centrifugal separator in accordance with claim 1, wherein said stator assembly further comprises an intake nozzle extending through said second open end of said cylindrical drum, said intake nozzle comprising a first flow channel extending therethrough for providing flow communication between said inner radial portion of said interior and said third flow opening.

5. The centrifugal separator in accordance with claim 4, wherein said intake nozzle extends through said second open end of said cylindrical drum such that a second annular flow channel is defined between said intake nozzle and said cylindrical drum, said second annular flow channel providing flow communication between said outer radial portion of said interior and said second flow opening.

6. The centrifugal separator in accordance with claim 1, wherein said second flow opening is oriented radially within said housing relative to the longitudinal axis, said stator assembly further comprising a ring member extending circumferentially about said housing and defining an annular plenum therebetween, said ring member positioned such that said annular plenum and said second flow opening are in flow communication.

7. The centrifugal separator in accordance with claim 1, wherein an annular cavity is defined between said housing and said cylindrical drum, and wherein said cylindrical drum is spaced from said stator assembly such that a leakage flow path defined therebetween provides flow communication to said annular cavity.

8. The centrifugal separator in accordance with claim 1 further comprising a bearing coupled between said stator assembly and said rotor assembly, wherein said bearing is a hydrodynamic thrust bearing fabricated at least partially from tungsten carbide material.

9. The centrifugal separator in accordance with claim 1, wherein said cylindrical drum comprises an outer surface having at least one balancing member extending therefrom, said at least one balancing member selectively abradable from said cylindrical drum to modify a center of mass thereof.

10. A centrifugal separator for use in separating a mixed stream of at least a first fluid and a second fluid, said centrifugal separator comprising:
a stator assembly comprising a housing defining a longitudinal axis of the centrifugal separator, wherein said housing extends from a first end to a second end along the longitudinal axis, and wherein said housing comprises:
a first flow opening defined at said first end of said housing;
a second flow opening defined at said first end of said housing; and
a third flow opening defined at said second end of said housing; and
a rotor assembly positioned within said housing, said rotor assembly comprising:
a cylindrical drum that comprises:
a first open end, said cylindrical drum configured to receive the mixed stream through said first open end;
a second open end; and
an interior comprising an outer radial portion and an inner radial portion, said outer radial portion in flow communication with said first flow opening and said third flow opening, and said inner radial portion in flow communication with said second flow opening, wherein said cylindrical drum is rotatable within said housing such that the first fluid flows along said outer radial portion, and such that the second fluid flows along said inner radial portion; and
a rotor shaft coupled to said cylindrical drum, wherein said rotor shaft comprises a side wall defining an internal flow channel that provides flow communication between said inner radial portion of said interior and said second flow opening.

11. The centrifugal separator in accordance with claim 10, wherein said rotor shaft extends through said first open end of said cylindrical drum such that a first annular flow channel is defined between said rotor shaft and said cylindrical drum, said first annular flow channel providing flow communication between said outer radial portion of said interior and said first flow opening.

12. The centrifugal separator in accordance with claim 10, wherein said stator assembly further comprises a plug member extending through said second open end of said cylindrical drum, said plug member configured to restrict fluid flow therethrough.

13. The centrifugal separator in accordance with claim 12, wherein said plug member is oriented such that a second annular flow channel is defined between said plug member and said cylindrical drum, said second annular flow channel providing flow communication between said outer radial portion of said interior and said third flow opening.

14. The centrifugal separator in accordance with claim 10, wherein said rotor assembly further comprises an intake nozzle coupled to said rotor shaft.

15. The centrifugal separator in accordance with claim 14, wherein said intake nozzle extends from said rotor shaft and is positioned within said interior of said cylindrical drum.

16. The centrifugal separator in accordance with claim 10, wherein said side wall of said rotor shaft has a radial opening defined therein, said radial opening in selective flow communication with said second flow opening as said rotor shaft rotates.

17. The centrifugal separator in accordance with claim 16, wherein said stator assembly further comprises:
a first ring member extending circumferentially about said rotor shaft and defining an annular plenum therebetween, said first ring member positioned such that said annular plenum and said radial opening are in flow communication; and
a flow tube extending between said first ring member and said second flow opening such that flow communication is provided therebetween.

18. The centrifugal separator in accordance with claim 10, wherein said third flow opening is oriented radially within said housing relative to the longitudinal axis, said stator assembly further comprising a second ring member extending circumferentially about said housing and defining an annular plenum therebetween, said second ring member positioned such that said annular plenum and said third flow opening are in flow communication.

19. The centrifugal separator in accordance with claim 10 further comprising a bearing coupled between said stator assembly and said rotor assembly, wherein said bearing is a hydrodynamic thrust bearing fabricated at least partially from tungsten carbide material.

20. The centrifugal separator in accordance with claim 10, wherein said cylindrical drum comprises an outer surface having at least one balancing member extending therefrom, said at least one balancing member selectively abradable from said cylindrical drum to modify a center of mass thereof.
